(19) United States
(12) Patent Application Publication
(10) Pub. No.: US 2025/0088081 A1
(43) Pub. Date: Mar. 13, 2025

(54) METHOD FOR MANUFACTURING STATOR COIL, METHOD FOR MANUFACTURING ROTATING ELECTRICAL MACHINE, STATOR, AND ROTATING ELECTRICAL MACHINE

(71) Applicant: Mitsubishi Electric Corporation, Tokyo (JP)

(72) Inventors: Yutaka HIROTA, Tokyo (JP); Takayuki TAKESHITA, Tokyo (JP); Hiroki KOBAYASHI, Tokyo (JP)

(73) Assignee: Mitsubishi Electric Corporation, Tokyo (JP)

(21) Appl. No.: 18/725,911

(22) PCT Filed: Jan. 17, 2023
(86) PCT No.: PCT/JP2023/001114

§ 371 Date: Jul. 1, 2024

(30) Foreign Application Priority Data
Jan. 19, 2022 (JP) 2022-006200

(51) Int. Cl. H02K 15/04; B21F 3/02; H02K 3/28

(52) U.S. Cl. CPC H02K 15/0432; B21F 3/02; H02K 3/28

(57) ABSTRACT

This method for manufacturing a stator coil of a rotating electrical machine includes: a winding step of arraying the plurality of conductive wires in one row and winding, while maintaining an arrayed state, each of the conductive wires a predetermined number of times on each of a plurality of the reels having different diameters, to form a plurality of coils connected to each other by a jumper wire; a gripping step of detaching each of the plurality of coils from the corresponding reel while maintaining the arrayed state of the plurality of conductive wires; and an insertion step of disposing, in the stator core, the plurality of gripped coils so as to stack the coils in an order of insertion into the core slots, and then inserting the coils into the core slots.

### TECHNICAL FIELD

The present disclosure relates to a method for manufacturing a stator coil, a method for manufacturing a rotating electrical machine, a stator, and a rotating electrical machine.

### BACKGROUND ART

A conventional method for manufacturing a stator coil includes winding conductive wires on reels without arraying the conductive wires and further includes taking out the resultant coils from the reels after completion of the winding (see, for example, Patent Document 1).

### CITATION LIST

### Patent Document

Patent Document 1: Japanese Laid-Open Patent Publication No. 2018-82554

### SUMMARY OF THE INVENTION

### Problem to be Solved by the Invention

However, since the conductive wires have not been wound in a regularly arrayed manner, the conductive wires might intersect with one another at straight portions of the coils. Consequently, each of the straight portions is bulged and accordingly has an increased dimension.

In addition, when the coils are pushed into core slots while being kept in the disarrayed state, the coils are intertwined with one another in the core slots so that the coils are bent and bulged. Thus, a problem arises in that the proportion of the coils in the core slots becomes lower (the number of the coils inserted into the core slots becomes smaller) than that in an arrayed state, whereby motor performance is not increased.

Furthermore, when the coils are forcedly pushed in, a problem arises in that an insulation coating on each of the coils is scratched on the edge of an opening portion of the corresponding core slot, and the scratching leads to poor insulation.

Moreover, in a case where three or more coils connected to each other by jumper wires are sequentially inserted into core slots one by one, the coils need to be temporarily placed outside of the core so as not to hinder the insertion operation. At the time of such temporary placement, the jumper wires do not have sufficient lengths for placing the coils outside of the core, and the coils obtained through winding need to be unwound by half a round. However, the unwinding of the coils leads to disarray of windings. Thus, when the coils are inserted again, an operation of restoring the arrayed state has to be performed. Therefore, a problem arises in that it takes time and effort to insert the coils, whereby productivity is poor.

In view of the above problems, it has been desired to develop a method for manufacturing a stator coil, in which a coil mounting step for a distributed-winding stator coil allows, while maintaining an array achieved in a winding step, a coil to be inserted into a core easily and without impairing insulation performance.

The present disclosure has been made to solve the above problems, and an object of the present disclosure is to provide a method for manufacturing a stator coil, the method achieving a high quality and a high productivity.

### Means to Solve the Problem

A method for manufacturing a stator coil according to the present disclosure is
a method for manufacturing a stator coil, in which a plurality of conductive wires are wound on reels so as to form coils and the formed coils are inserted into slots of a stator core, the method including:
a winding step of arraying the plurality of conductive wires in one row and winding, while maintaining an arrayed state, each of the conductive wires a predetermined number of times on each of a plurality of the reels having different diameters, to form a plurality of coils connected to each other by a jumper wire;
a gripping step of detaching each of the plurality of coils from the corresponding reel while maintaining the arrayed state of the plurality of conductive wires; and
an insertion step of disposing, in the stator core, the plurality of gripped coils so as to stack the coils in an order of insertion into the slots, and then inserting the coils into the slots.

### Effect of the Invention

The method for manufacturing a stator coil according to the present disclosure makes it possible to easily perform an operation of inserting a plurality of coils connected to each other by a jumper wire and smoothly insert the coils into slots of a stator core. Consequently, a stator core can be manufactured so as to achieve a high quality and a high productivity, without damaging insulation coatings on the coils.

### BRIEF DESCRIPTION OF THE DRAWINGS

FIGS. 1(a) to 1(c) are external views of a stator according to embodiment 1, FIG. 1(a) being a perspective view of a stator core, FIG. 1(b) being a perspective view showing a state where a rotor has been mounted to the stator core, FIG. 1(c) being a perspective cross-sectional view of FIG. 1(b).

FIG. 2 is a diagram for explaining a winding device for manufacturing a three-continuous coil to be mounted in the stator core according to embodiment 1.

FIG. 3 is a schematic diagram for explaining the positional relationship among constituents as seen from the right side on the drawing sheet of FIG. 2.

FIG. 4 is a front view of a winding unit having a dedicated reel according to embodiment 1.

FIG. 5 is a side view of the dedicated reel according to embodiment 1.

FIGS. 6(a) and 6(b) are diagrams for explaining a distortion remover according to embodiment 1, FIG. 6(a) being a perspective view, FIG. 6(b) being a cross-sectional view.

FIG. 7 shows a state where a coil has been obtained through winding on a reel, according to embodiment 1.

FIG. 8 is a front view of the winding unit showing a state of a winding end.

FIGS. 9(a) to 9(c) show states where the dedicated reel in embodiment 1 has been taken out from the winding unit, FIG. 9(a) being a front view, FIG. 9(b) being a side view, FIG. 9(c) showing a state where coils composing the three-continuous coil are connected to each other by jumper wires.

FIGS. 10(a) and 10(b) are diagrams for explaining a grip-switching step according to embodiment 1, FIG. 10(a) being a front view, FIG. 10(b) being a diagram as seen from the right side on the drawing sheet of FIG. 10(a).

FIG. 11 shows a state where any of the coils is gripped by coil chucks in the grip-switching step according to embodiment 1.

FIG. 12 is a diagram for explaining a state where the coil chucks in a state of gripping the coil are mounted on a chuck fixation jig in an insertion step according to embodiment 1.

FIG. 13 is a diagram for explaining a state where two stages of coil chucks in a state of gripping coils are stacked in the insertion step according to embodiment 1.

FIG. 14 is a diagram for explaining a state where three stages of coil chucks in a state of gripping coils are stacked in the insertion step according to embodiment 1.

FIG. 15 is a diagram for explaining a state where the three stages of coil chucks in the state of gripping the coils and having been stacked are inserted into the stator core in the insertion step according to embodiment 1.

FIG. 16 shows the relationship among the coils, the coil chucks, and fixation jigs as seen in the direction A in FIG. 15.

FIGS. 17(a) to 17(c) are diagrams for explaining the insertion step according to embodiment 1, FIG. 17(a) showing a situation where a small coil at a first stage is inserted, FIG. 17(b) showing a situation where a large coil at a second stage is inserted, FIG. 17(c) showing a situation where a small coil at a third stage is inserted.

FIGS. 18(a) to 18(c) are diagrams for explaining a process of inserting any of the coils into a corresponding core slot by using a coil pusher, FIG. 18(a) showing a situation where the insertion has been started, FIG. 18(b) showing a situation where the insertion is progressing, FIG. 18(c) showing a situation where the insertion has been completed.

FIG. 19 is a diagram for explaining a state where the coil is inserted and the relationship between a coil chuck width dimension and a core slot opening dimension.

FIG. 20 is a diagram for explaining a winding device for manufacturing a three-continuous coil to be mounted in the stator core according to embodiment 2.

FIG. 21 is a cross-sectional view showing a state where conductive wires are inserted into a distortion remover according to embodiment 2.

FIG. 22 is a diagram for explaining a state where the winding device for manufacturing a three-continuous coil to be mounted in the stator core according to embodiment 2 has finished winding on a reel for a small coil a specified number of times.

FIGS. 23(a) to 23(c) are diagrams for explaining states of the conductive wires inserted into the distortion remover according to embodiment 2, FIG. 23(a) showing a situation where the conductive wires have yet to be interchanged, FIGS. 23(b) and 23(c) showing situations where the conductive wires have been interchanged.

FIG. 24 is a diagram for explaining a state where the conductive wires have been interchanged in the winding device for manufacturing a three-continuous coil to be mounted in the stator core according to embodiment 2.

FIGS. 25(a) to 25(c) are diagrams for explaining states of the conductive wires inserted into the distortion remover according to embodiment 2, FIG. 25(a) showing a situation where the conductive wires have yet to be interchanged, FIGS. 25(b) and 25(c) showing situations where the conductive wires have been interchanged.

FIG. 26 is a diagram for explaining an arrangement order of a three-continuous coil to be mounted in the stator core according to embodiment 2.

FIG. 27 is a diagram for explaining an arrangement order of a three-continuous coil to be mounted in the stator core according to embodiment 2.

FIGS. 28 (a) to 28 (c) are diagrams for explaining arrangement orders of the conductive wires in core slots of the stator core according to embodiment 2, FIGS. 28(a) to 28(c) showing the respective coils among which the order of the conductive wires inserted in the core slots differs.

FIG. 29 is a diagram for explaining an arrangement order of a three-continuous coil to be mounted in the stator core according to embodiment 2.

FIGS. 30(a) and 30(b) are diagrams for explaining states of jumper wires of the conductive wires in core slots of the stator core according to embodiment 2.

FIGS. 31(a) to 31(c) are diagrams for explaining attaching of the coil chucks to the coils to be inserted into the stator core according to embodiment 3, FIG. 31(a) showing a state where a third coil is attached, FIG. 31(b) showing a state where a second coil is attached, FIG. 31(c) showing a state where a first coil is attached.

FIGS. 32(a) to 32(c) are diagrams for explaining arrangement orders of the conductive wires in the core slots of the stator core according to embodiment 3, FIG. 32(a) showing a state of the third coil, FIG. 32(b) showing a state of the second coil, FIG. 32(c) showing a state of the first coil.

FIGS. 33(a) to 33(c) are diagrams for explaining states of jumper wires of the conductive wires in the core slots of the stator core according to embodiment 3.

### DESCRIPTION OF EMBODIMENTS

Hereinafter, methods for manufacturing a stator coil according to preferred embodiments of the present disclosure will be described with reference to the drawings. The same features and corresponding parts are denoted by the same reference characters, and detailed description thereof will be omitted.

### Embodiment 1

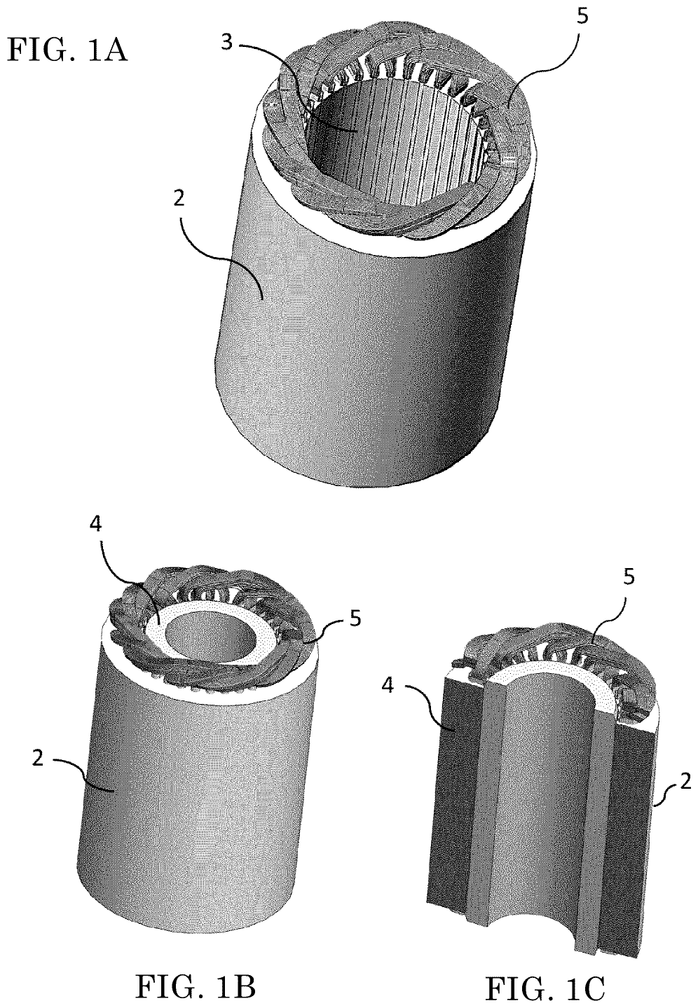

FIG. 1(a) is a perspective view showing the appearance of a stator core 2 of a stator manufactured in the present embodiment and the shapes of coils 5 in a state of having been inserted into the stator core 2. The stator core 2 in FIG. 1(a) is, for example, a stator core 2 for an electric motor having three layers, four poles, and 36 slots. In the stator core 2, coils 5 obtained by performing concentric lap winding with distributed windings are accommodated in core slots 3.

FIG. 1(b) is a perspective view showing a state where a rotor 4 has been mounted to the stator core 2. The rotor 4 is used for a three-phase induction motor and includes: a rotor core obtained by stacking iron cores in an axial direction; and a conductor (not shown) through which induced current flows. Alternatively, the rotor 4 may be used for a three-phase synchronous motor in which magnets have been disposed on the rotor core.

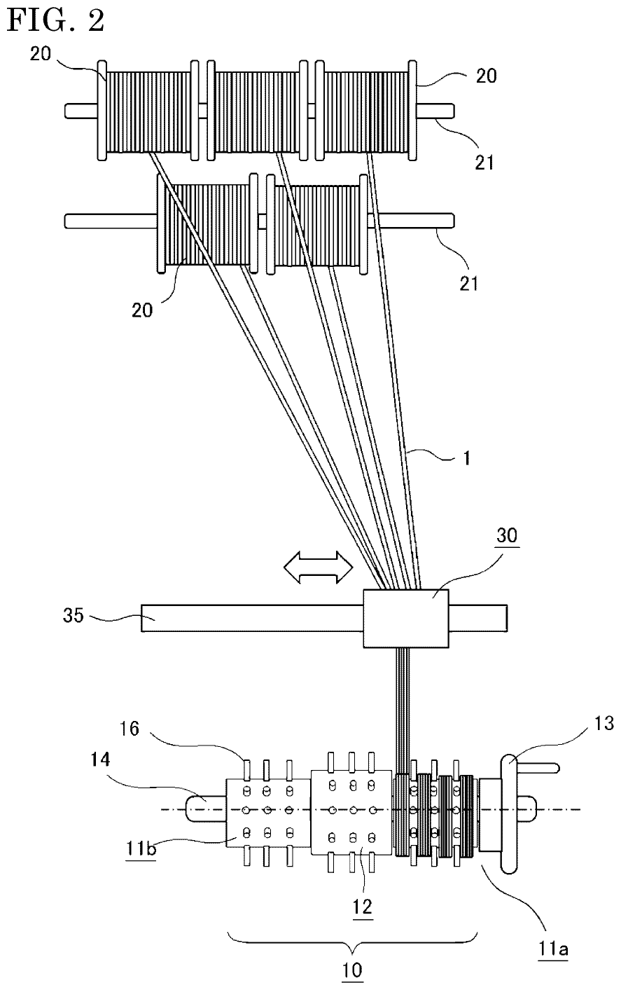

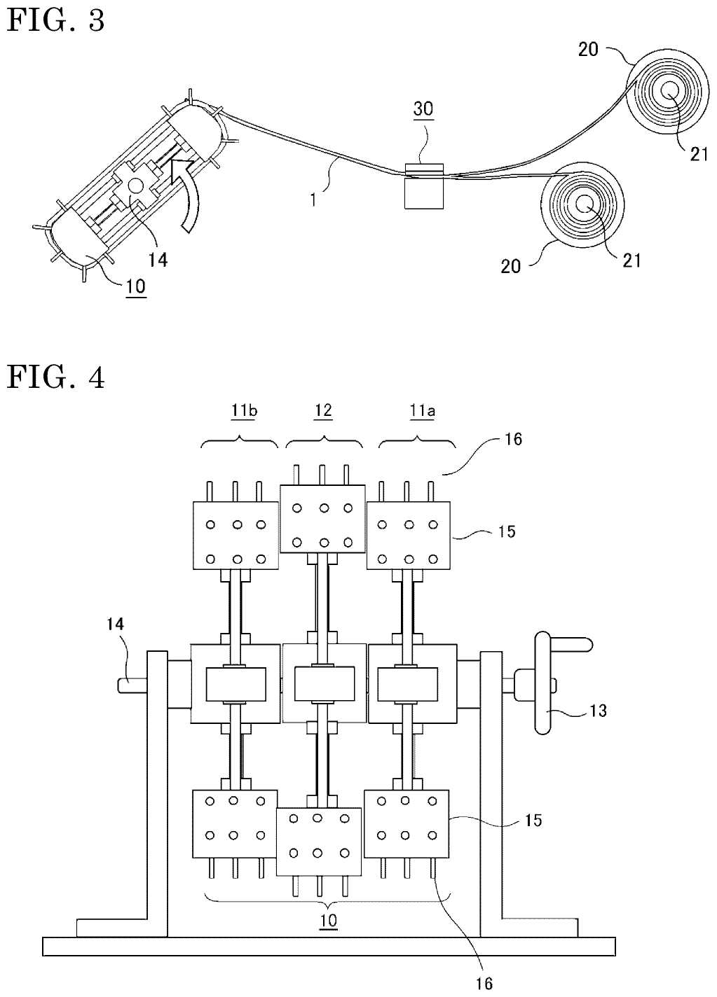

FIG. 2 and FIG. 3 show a winding device for manufacturing a three-continuous coil to be mounted in the stator core 2. FIG. 2 is a front view, and FIG. 3 is a schematic diagram for explaining the positional relationship among constituents as seen from the right side in FIG. 2.

In FIG. 2, five conductive wires 1 supplied from wire material drums 20 are inserted into a distortion remover 30 so as to be formed as a bundle in a state of being laterally arrayed in one row, and then the bundle is wound on a dedicated reel 10 so as to form a coil composed of three continuous coils (three-continuous coil). Specifically, a reel 11a for a small coil, a reel 12 for a large coil, and a reel 11b for a small coil are joined together as a result of being penetrated by a rotation shaft 14 so as to compose the dedicated reel 10, and the bundle of five conductive wires 1 each having a circular cross-sectional shape is continuously wound a specified number of times on the reel 11a, the reel 12, and the reel 11b in this order. It is noted that the reels 11a, 11b, and 12 have such structures as to be separable when the rotation shaft 14 is detached.

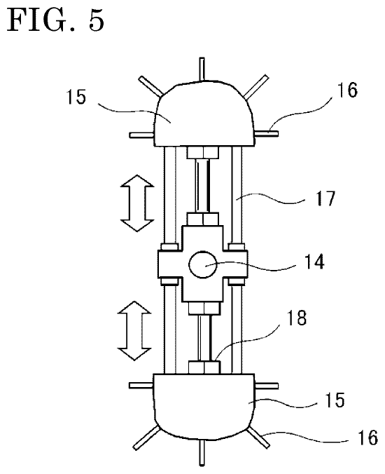

FIG. 4 is a front view of a winding unit having the dedicated reel 10, and FIG. 5 is a side view of the dedicated reel 10. Although the dedicated reel 10 in the present embodiment is dedicated to three-continuous coils, the dedicated reel 10 is not limited thereto. As shown in FIG. 5, a plurality of restricting pins 16 are driven into the reels 11a, 11b, and 12 so as to be arranged in an axial direction and a rotation direction of the rotation shaft 14 such that the bundle of five conductive wires 1 is wound around the rotation shaft 14 parallelly to the axial direction of the rotation shaft 14 along rounded portions of conductive wire winding portions 15 having semi-oval shapes on both sides. Linear slide mechanisms 17 which join together the conductive wire winding portions 15 opposed to each other have no members for restricting the conductive wires 1 and allow the conductive wires 1 to be wound straight so as not to be loosened, by utilizing a tension (optimal tension) applied to the conductive wires 1. Each of the slide mechanisms 17 is configured to be stretchable/contractable in the directions indicated by the arrows in FIG. 5 such that the coil 5 can be easily detached after winding in the direction indicated by the arrow in FIG. 3 is finished.

### <Winding Step>

Next, a procedure of a winding step to be performed by the above winding device will be described.

(1) First, as shown in FIG. 2 and FIG. 3, shafts 21 are inserted through the five wire material drums 20, and the conductive wires 1 are set so as to be able to be drawn out from the respective wire material drums 20.

(2) The dedicated reel 10 is set such that the rotation shaft 14 is inserted therethrough. A rotation handle 13 provided at an end portion of the rotation shaft is rotated to rotate the dedicated reel 10 in the direction indicated by the arrow in FIG. 3 and wind the conductive wires 1. At this time, as shown in FIG. 2, winding is started at the right end of the reel 11a for a small coil, and the five conductive wires 1 are wound parallelly between the restricting pins 16 so as not to be disarrayed.

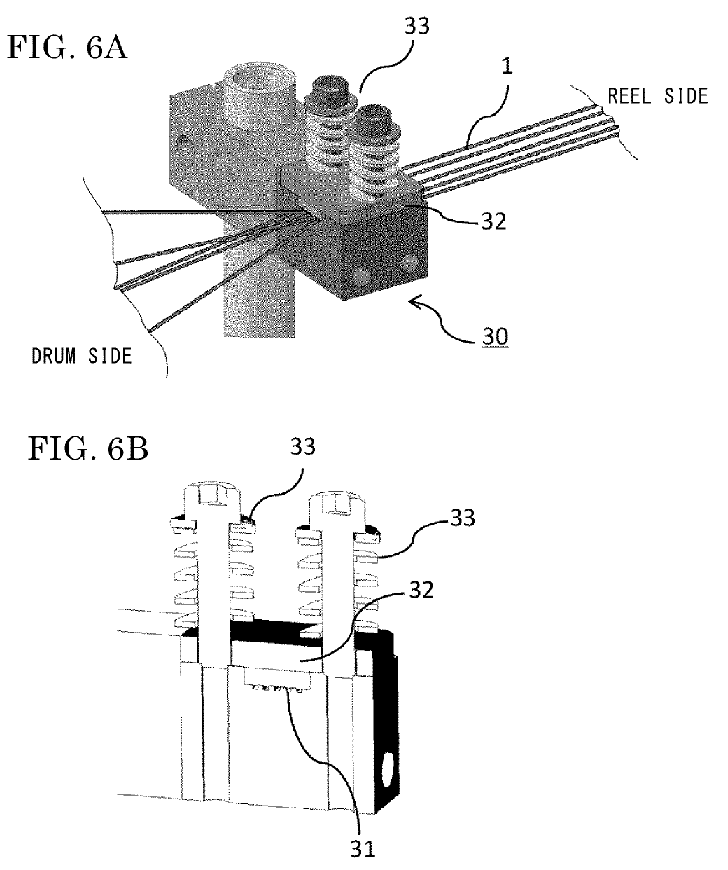

(3) The conductive wires 1 simultaneously drawn out from the respective wire material drums 20 are caused to pass through the distortion remover 30 shown in FIG. 6(a), to enter a state where: curled portions formed at the time of winding the conductive wires 1 on the wire material drums 20 are straightened; and the optimal tension is applied to the conductive wires 1.

Specifically, as shown in FIG. 6(b), grooves 31, the number of which is equal to the number of the conductive wires 1 to be wound (in the present embodiment, five), are formed parallelly in the distortion remover 30, and, by passage through the grooves 31, bent portions of the conductive wires 1 are straightened and the conductive wires 1 are arrayed at a pitch for performing winding on the dedicated reel 10. In addition, as shown in FIGS. 6(a) and 6(b), a pressing lid 32 is provided such that the conductive wires 1 are not moved out of the grooves 31. The pressing lid 32 has such a structure as to be able to adjust pressing force by springs 33 and can apply the optimal tension to the conductive wires 1 such that the conductive wires 1 are not loosened when being wound on the dedicated reel 10.

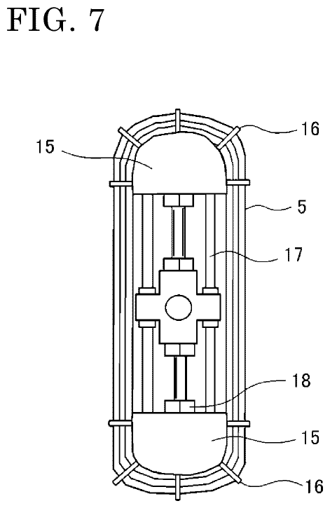

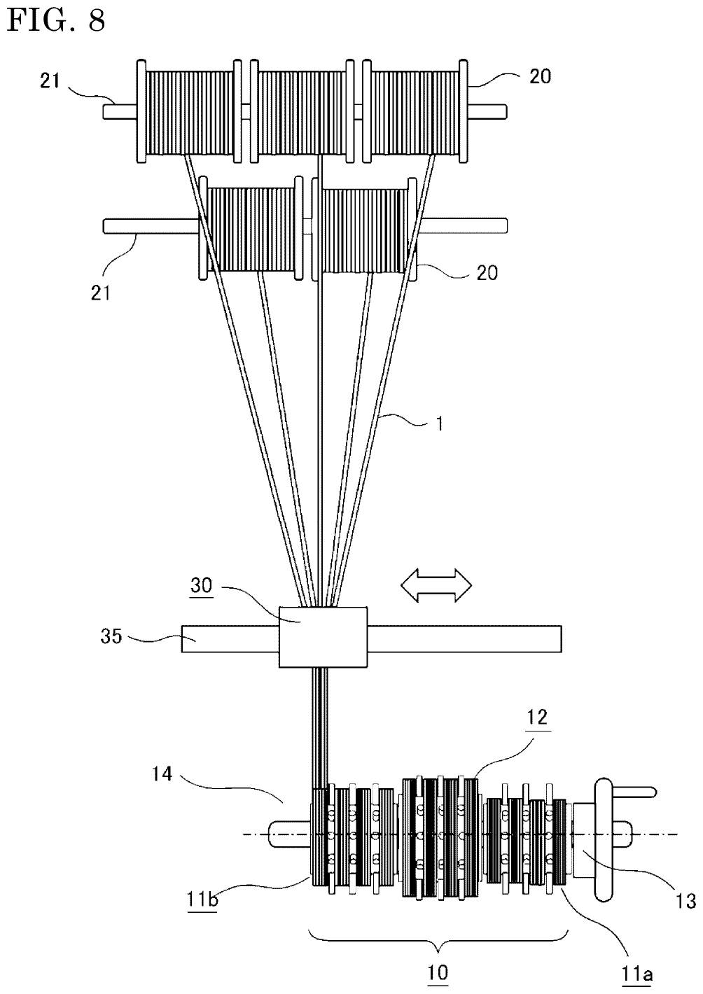

(4) When winding on the reel 11a for a small coil the specified number of times is finished as shown in FIG. 7, the conductive wires 1 are moved to a position for performing winding on the reel 12 for a large coil, and are wound in the same manner as that described above without cutting the conductive wires 1. The distortion remover 30 includes a movement means 35 and allows winding while being slid in the direction of the rotation shaft 14 so as not to bend the conductive wires 1, with the angle of each of the conductive wires 1 relative to the dedicated reel 10 being constantly kept as a right angle. FIG. 8 shows a position at a winding end to which the distortion remover 30 has been moved. At this time, the conductive wires 1 have been wound on the reels 11a, 11b, and 12, and a three-continuous coil 5 has been formed.

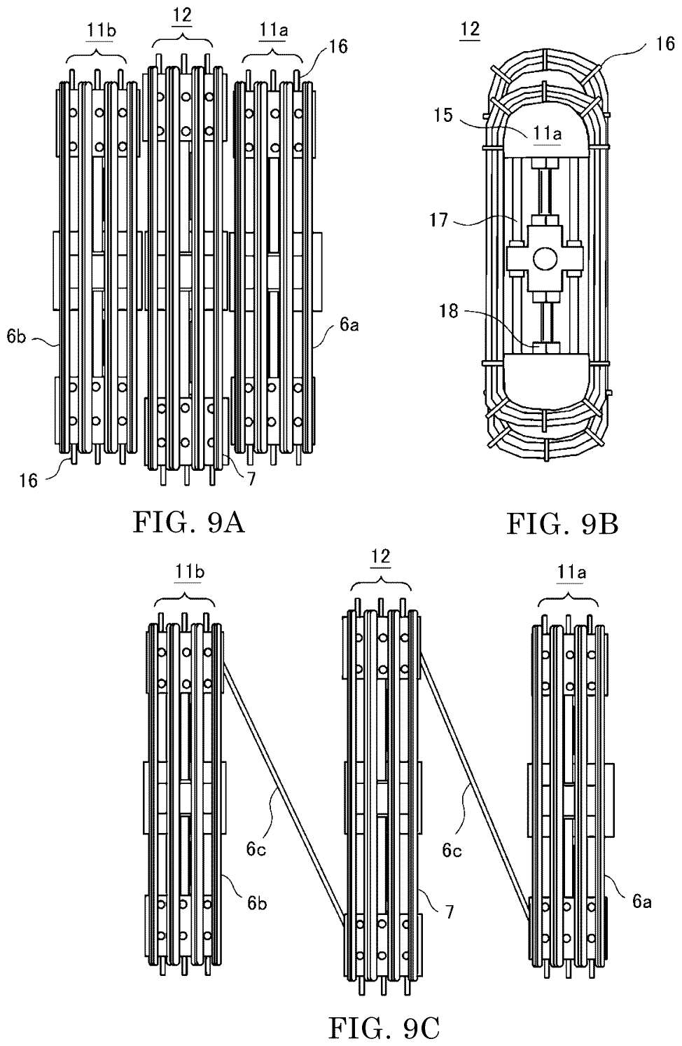

(5) After the winding is finished, the reels 11a, 12, and 11b are detached from the rotation shaft 14 as shown in FIGS. 9(a) and 9(b). FIG. 9(a) is a front view of the detached reels, and FIG. 9(b) is a side view thereof. FIG. 9(c) shows a state where coils composing the three-continuous coil 5 obtained through winding on the reels 11a, 12, and 11b detached from the rotation shaft 14 are connected to each other by jumper wires 6c. The three-continuous coil 5 is composed of a small coil 6a obtained through winding on the reel 11a, a large coil 7 obtained through winding on the reel 12, and a small coil 6b obtained through winding on the reel 11b. These coils are connected to each other by the jumper wires 6c.

### <Grip-Switching Step>

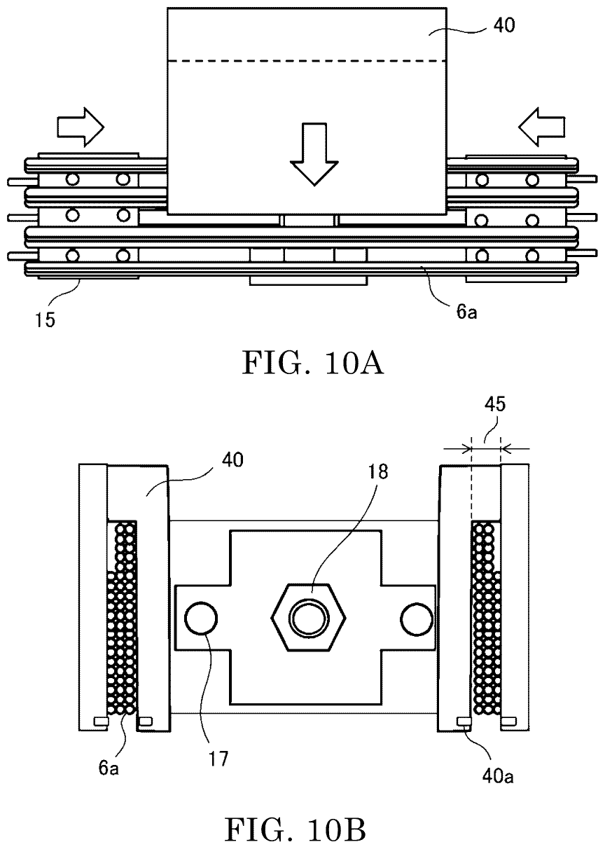

When the winding step is finished, a “grip-switching step” is performed as shown in FIGS. 10(a) and 10(b). The grip-switching step includes: detaching the small coil 6a, the large coil 7, and the small coil 6b which compose the coil 5, from the reels 11a, 11b, and 12 while maintaining the winding shapes; and performing grip-switching such that the coils are gripped by coil chucks 40.

(1) FIG. 10(a) is a front view, and FIG. 10(b) is a diagram as seen from the right side on the drawing sheet of FIG. 10(a). As shown in FIG. 10(a), between the small coil 6a and the reel 11a, corresponding ones of the coil chucks 40 are inserted in the direction indicated by an arrow such that straight portions of the small coil 6a are inserted within coil chuck widths 45 of the coil chucks 40. Each of the coil chuck widths 45 is set to be smaller than a core slot opening width 44 so as to make it easy to insert the small coil 6a into core slots 3 (see FIG. 19 described later).

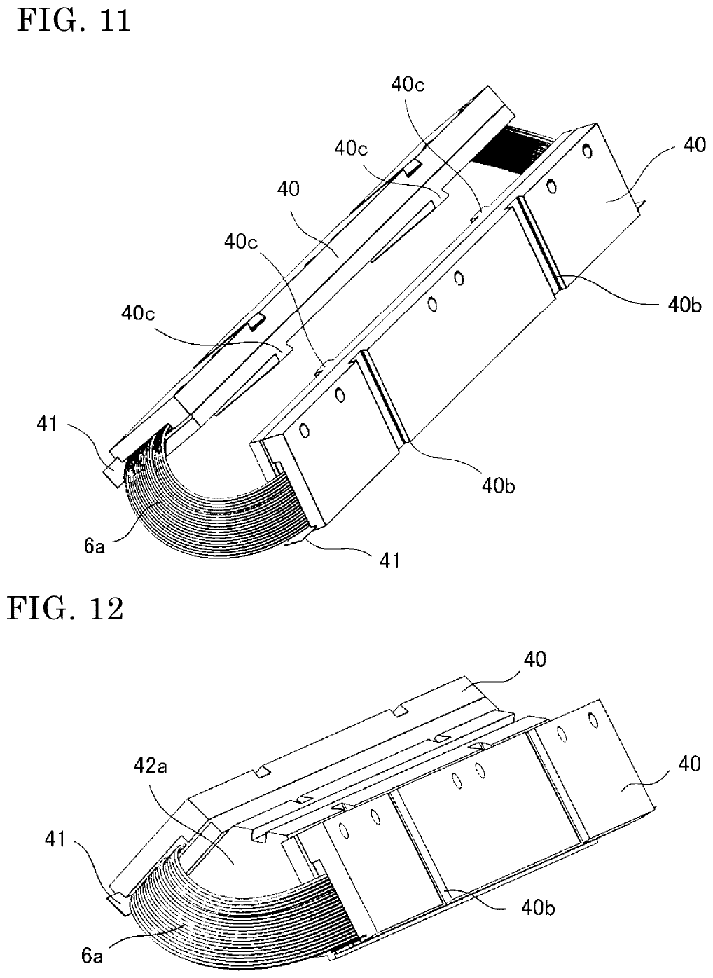

(2) As shown in FIG. 10(b), shutters 41 (see FIG. 11) made of thin sheets are inserted into shutter insertion grooves 40a formed at ends of the coil chucks 40 such that the small coil 6a does not fall off from the coil chucks 40.

(3) Thereafter, the conductive wire winding portions 15 on both sides of the reel are slid by the slide mechanisms 17 (see FIG. 5) in the directions toward the center that are indicated by arrows in FIG. 10(a), and the restricting pins 16 are retracted to such positions as not to allow occurrence of mutual interference, whereby the small coil 6a is detached from the reel 11a. It is noted that the slide mechanisms 17 are locked by a locking mechanism 18 during winding, and thus the positions of the conductive wire winding portions 15 are fixed during winding of the conductive wires.

(4) These operations are performed on the small coil 6a obtained through winding on the reel 11a, the large coil 7 obtained through winding on the reel 12, and the small coil 6b obtained through winding on the reel 11b in this order. In this manner, the same operations are repeated. Thus, the three-continuous coil is detached from the dedicated reel 10. Current for a same phase among the three phases flows through the small coil 6a, the large coil 7, and the small coil 6b. Each of the small coils 6a and 6b has a coil pitch which is a width in a circumferential direction between the straight portions thereof to be inserted into slots. The coil pitch of each of the small coils 6a and 6b is smaller than the coil pitch of the large coil 7. In an example in the present embodiment, the coil pitch of each of the small coils 6a and 6b is a pitch corresponding to seven slots, and the coil pitch of the large coil 7 is a pitch corresponding to nine slots.

### <Insertion Step>

Next, an “insertion step” of inserting the three-continuous coil into core slots 3 will be described.

FIG. 11 shows a state where, for example, the small coil 6a is gripped by the corresponding coil chucks 40 in the aforementioned grip-switching step.

(1) In preparation for insertion, the coil chucks 40 are mounted on a fixation jig 42a for chucks first, as shown in FIG. 12. As shown in FIG. 11, each of the coil chucks 40 has dovetails and dovetail grooves (dovetail grooves 40b on the nearer side on the drawing sheet and dovetails 40c on the farther side on the drawing sheet) formed through machining. When the dovetail grooves 40b and the dovetails 40c are fitted, the coil chucks 40 are positioned and fixed.

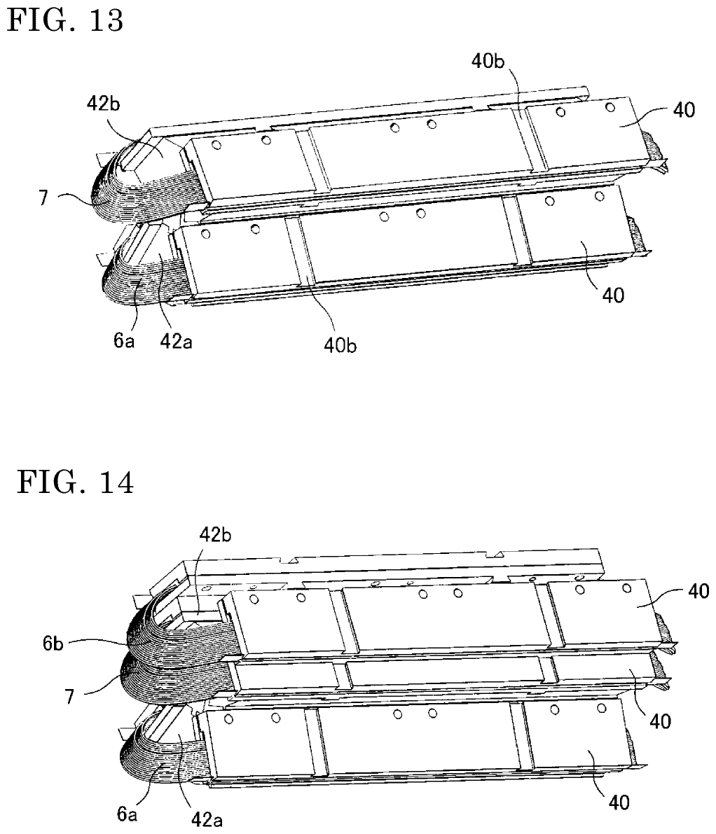

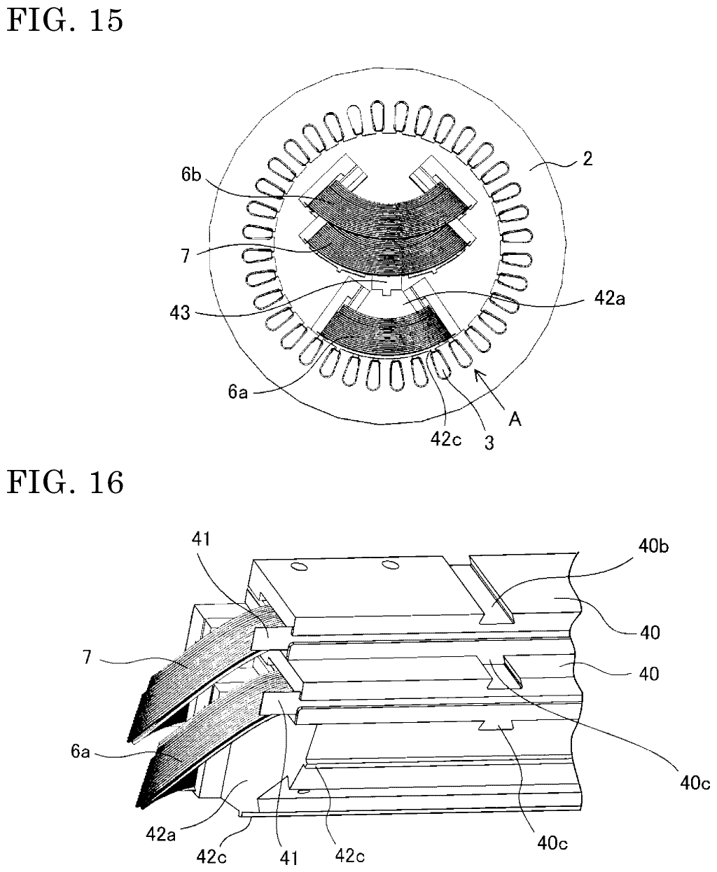

(3) The large coil 7 gripped by the corresponding coil chucks 40 is stacked on the small coil 6a as in FIG. 13, and furthermore, the small coil 6b gripped by the corresponding coil chucks 40 is stacked on the large coil 7 as in FIG. 14. Thus, these coils are set in three stages. Then, these coils are mounted in the stator core 2. At this time, as shown in FIG. 15, the fixation jig 42a for positioning the small coil 6a, a fixation jig 42b for positioning the large coil 7, and a jig fixation spacer 43 are used to position and fix each of the small coil 6a, the large coil 7, and the small coil 6b, and positioning protrusions 42c formed on the fixation jig 42a are engaged with corresponding core slots 3. By such a configuration, the small coil 6a, the large coil 7, and the small coil 6b gripped by the coil chucks 40 are disposed in the stator core 2 so as to be stacked in a radial direction from a side closer to the core slots 3, and thus, can be held in the stator core 2 without hindering insertion of any coil among the small coil 6a, the large coil 7, and the small coil 6b into corresponding core slots 3.

(4) As described above, in the example in the present embodiment, the coil pitch of each of the small coils 6a and 6b is the pitch corresponding to seven slots, and the coil pitch of the large coil 7 is the pitch corresponding to nine slots. Therefore, when each of the small coils 6a and 6b is set into the corresponding core slots 3 via the positioning protrusions 42c in a state where the corresponding coil chucks 40 are attached to both side surfaces of the fixation jig 42a, the coil is set at positions away from each other exactly by the pitch corresponding to seven slots as shown in FIG. 15. Likewise, when the large coil 7 is set into the corresponding core slots 3 via positioning protrusions 42c of the fixation jig 42b in a state where the corresponding coil chucks 40 are attached to both side surfaces of the fixation jig 42b for positioning, the coil is set at positions away from each other by the pitch corresponding to nine slots.

(5) FIG. 16 shows states of the small coil 6a and the large coil 7 as seen in the direction A in FIG. 15 (without showing the stator core 2). When the three-continuous coil is inserted into the radially inner side of the stator core 2 while being kept in the state in FIG. 15, and the positioning protrusions 42c are fitted into the corresponding core slots 3, the insertion positions for the corresponding coil are determined, and preparation for insertion is completed. Since the coils having yet to be inserted are kept on standby in such a form, the coils neither come apart nor are intertwined, and an insertion operation can be efficiently performed.

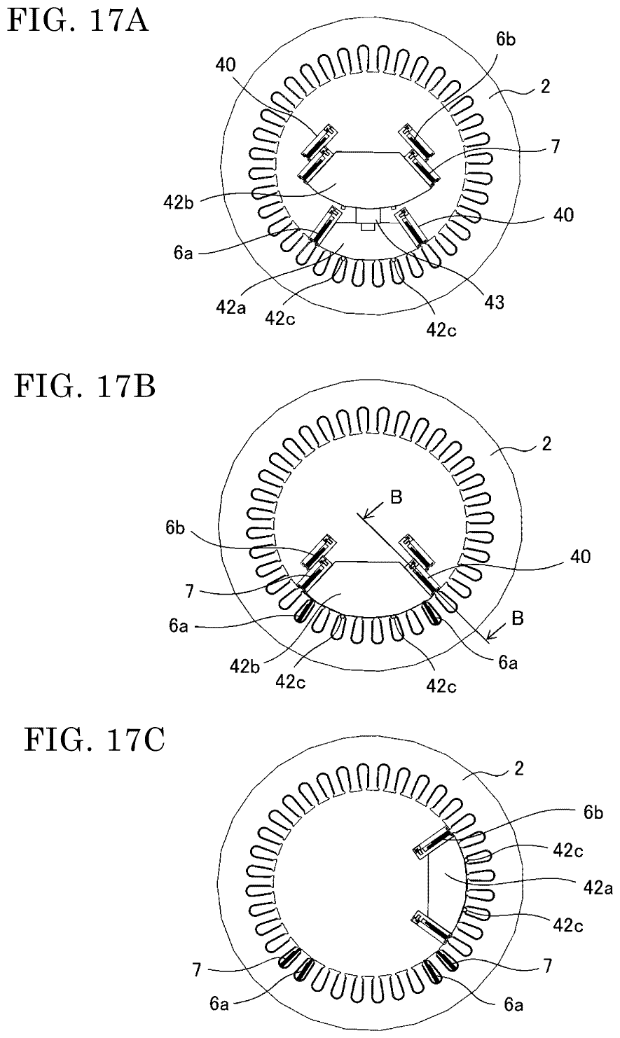

The order and the positions of insertion of the coils are predetermined. FIGS. 17(a) to 17(c) show, in time series, the manner in which each of the coils is inserted. FIG. 17(a) shows a state where the three stages of stacked coil chucks are inserted into the stator core having yet to be mounted with the coils. That is, FIG. 17(a) shows the same state as that shown in FIG. 15. However, in order to make it easy to see the fixation jigs 42a and 42b and the jig fixation spacer 43, FIG. 17(a) does not show portions, of the coils, that are placed on the jigs. As shown in FIG. 17(a), the coils are disposed in the stator core 2 so as to be stacked in the radial direction in the order of insertion into the corresponding core slots 3.

(6) As shown in FIG. 17(b), after the small coil 6a gripped by the corresponding coil chucks 40 fixed by the fixation jig 42a for positioning is inserted into the corresponding core slots 3, the jig fixation spacer 43 is detached, and the positioning protrusions 42c provided to the fixation jig 42b are fitted into the corresponding slots so as to determine the insertion positions for the large coil 7. Subsequently, as shown in FIG. 17(c), the large coil 7 is inserted into slots adjacent to the slots into which the small coil 6a has been inserted, and one of the straight portions of the small coil 6b is inserted into a slot which is the eighth one from the slot into which one of the straight portions of the large coil 7 has been inserted. In addition, the other straight portion of the small coil 6b is inserted into a slot adjacent to the slot into which the one of the straight portions of the large coil 7 has been inserted. After the insertion, the winding directions of the small coil 6a and the large coil 7 are the same as each other, and the winding direction of the small coil 6b is opposite to the winding directions of the small coil 6a and the large coil 7. In a case where current is conducted through the small coil 6a, the large coil 7, and the small coil 6b connected in series, the directions of magnetic fields generated from the small coil 6a and the large coil 7 which have the same coil winding direction are the same direction which is one of the radially inward direction and the radially outward direction, and meanwhile, the direction of a magnetic field generated from the small coil 6b having the opposite coil winding direction is the other one of the radially inward direction and the radially outward direction, i.e., is a direction opposite to the directions of the magnetic fields generated from the small coil 6a and the large coil 7. For the electric motor having 36 slots for three phases in the present embodiment, 12 three-continuous coils 5 are inserted into the stator core 2, and thus the above operations are repeated 12 times to complete the insertion of the stator coils.

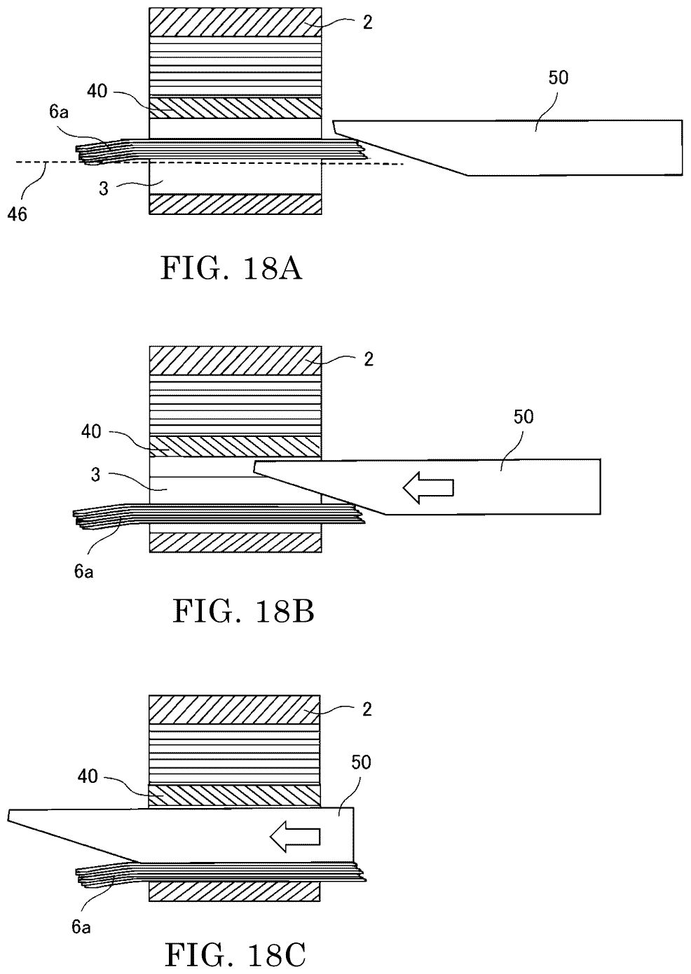

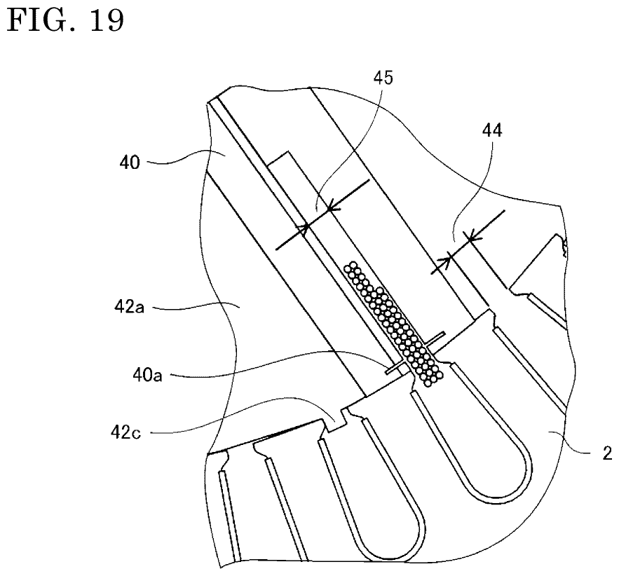

For example, a method for inserting the small coil 6a into a corresponding core slot 3 is as follows. That is, as shown in FIGS. 18(a), 18(b), and 18(c), a sheet-shaped coil pusher 50 having a tapered tip and having a thickness smaller than the core slot opening width 44 is inserted into a gap having the coil chuck width 45 (see FIG. 10(b)) and is slid in the axial direction (the direction indicated by an arrow in the drawing) of the stator core 2. Consequently, the tapered portion at the tip pushes the small coil 6a into the core slot 3 beyond a slot inlet boundary 46 between the coil chuck 40 and the core slot 3. Furthermore, the coil pusher 50 is moved over the entire length in the axial direction of the stator core 2. Thus, the small coil 6a can be completely inserted into the core slot 3 without being bent. Therefore, a stator having a higher space factor can be manufactured, and the stator can be used for manufacturing a small-sized and high-output motor.

FIG. 19 shows the relationship between the coil chuck width 45 and the core slot opening width 44. As described above, the coil chuck width 45 is set to be smaller than the core slot opening width 44 in order to make it easy to insert the small coil 6a into the core slot 3.

As described above, the conventional stator manufacturing method includes winding conductive wires on reels without arraying the conductive wires and further includes taking out the resultant coils by separating the reels after completion of the winding. Since the coils have not been regularly wound, the conductive wires cross one another at straight portions of the coils. Consequently, each of the straight portions is bulged and accordingly has an increased dimension as compared to the case of performing winding in an arrayed manner. Against this drawback, an operator needs to separate bundles of the coils immediately before inserting the coils into core slots, and needs to insert several conductive wires into each of the slots so as to obtain a width that is smaller than the opening width of the slot. Then, the coils are arrayed again after the insertion, and the coils are inserted while forming is being performed such that adjacent coil end portions do not overlap with each other. In this manner, the insertion step is an operation requiring specialized skills, whereby a problem arises in that operators are limited.

Meanwhile, in the method for manufacturing a stator coil according to the present embodiment, restriction by means of the jigs is performed in all the steps. Consequently, stators of the same quality can be manufactured without any conductive wires coming apart regardless of the skill of the operator.

In addition, the following advantage is obtained at the time of inserting the coils 6a, 7, and 6b into the corresponding core slots 3 of the stator. That is, since the coils have been arrayed within a dimension smaller than the opening width dimension of each of the slots, the coils can be easily inserted into the core slots 3, and an insulation coating on each of the conductive wires does not sustain any damage such as a flaw, resulting in prevention of deterioration of an insulation quality.

In addition, employment of this method for manufacturing a stator coil enables the coils to be disposed in the core slots 3 without being bent. Therefore, a stator having a higher space factor can be manufactured, and, by mounting a rotor to the manufactured stator, a small-sized and high-output motor having a high quality can be manufactured.

In the present embodiment, a case where the conductive wires each have a circular cross-sectional shape has been described. However, in the case of increasing the area of the conductors in the slots in order to increase the efficiency of an electric generator, the conductive wires may each have a rectangular cross section.

### Embodiment 2

Hereinafter, a method for manufacturing a stator coil and a structure of a stator according to embodiment 2 will be described with reference to the drawings, focusing on differences from the method and the structure according to embodiment 1. In embodiment 1, coils are formed by winding the conductive wires in an arrayed manner, and the coils are inserted into the core slots 3 with the array being maintained. Consequently, inductance might differ among the conductive wires owing to: a difference among the lengths of the respective conductive wires due to a difference among winding positions; or, in a case where the conductive wire positions in the core slots 3 are the same among the coils, distributions in magnetic saturation that occurs at the time of driving the motor and that occurs in adjacent teeth between which the core slots 3 are formed.

When the inductance differs among the conductive wires, the amplitude or the phase of current differs among the conductive wires, and circulation current that circulates between the conductive wires is generated. This circulation current is a factor in decreasing the efficiency of the motor. The present embodiment 2 is intended to inhibit generation of such circulation current, thereby suppressing the decrease in the efficiency of the motor.

Although, similar to embodiment 1, the structure of the stator will be described and the method for manufacturing a stator coil will be described step by step, a “grip-switching step” and an “insertion step” are the same as those in embodiment 1, and thus description thereof will be omitted.

### <Winding Step>

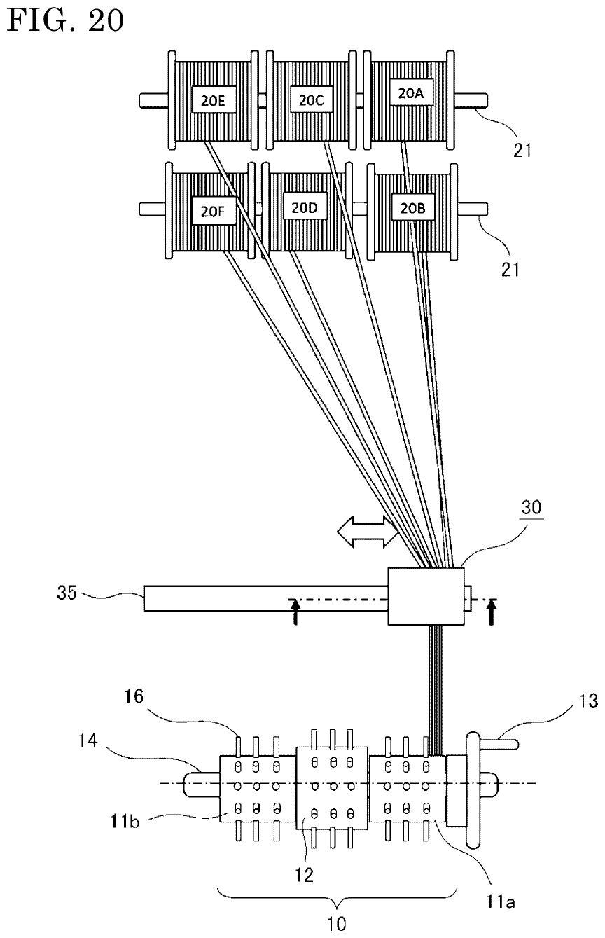

(1) First, as shown in FIG. 20, the shafts 21 are inserted through six wire material drums 20A to 20F, and conductive wires A to F are set so as to be able to be drawn out from the respective wire material drums 20A to 20F. Although description has been given in embodiment 1 with the number of the conductive wires being five, description will be given in embodiment 2 with the number of the conductive wires being six for simplifying the description.

(2) The dedicated reel 10 is set such that the rotation shaft 14 is inserted therethrough. The rotation handle 13 provided at the end portion of the rotation shaft is rotated to rotate the dedicated reel 10 and wind the conductive wires A to F. At this time, as shown in FIG. 20, winding is started at the right end of the reel 11a for a small coil, and the six conductive wires A to F are wound parallelly between the restricting pins 16 so as not to be disarrayed. In the same manner as in embodiment 1, as a first coil obtained through winding on the reel 11a for a small coil, a small coil 6a is formed through winding on the reel a specified number of times.

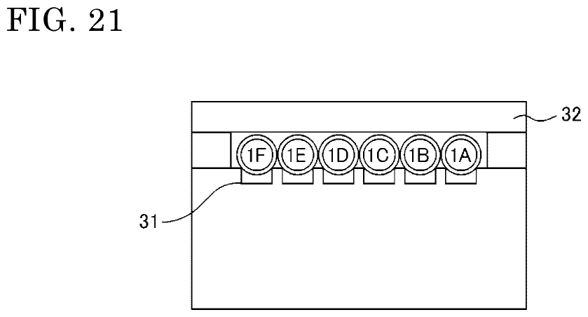

(3) The conductive wires A to F simultaneously drawn out from the respective wire material drums 20A to 20F are caused to pass through a distortion remover 30 shown in FIG. 21, to enter a state where: curled portions formed at the time of winding the conductive wires A to F on the wire material drums 20A to 20F are straightened; and the optimal tension is applied to the conductive wires A to F. In FIG. 21, 1A to 1F indicate the respective conductive wires, from the wire material drums 20A to 20F, which are to be wound at the first turn.

Specifically, as shown in FIG. 21, grooves 31, the number of which is equal to the number of the conductive wires A to F to be wound (in the present embodiment, six), are formed parallelly in the distortion remover 30, and, by passage through the grooves 31, bent portions of the conductive wires A to F are straightened and the conductive wires A to F are arrayed at a pitch for performing winding on the dedicated reel 10. In addition, the pressing lid 32 is provided such that the conductive wires A to F are not moved out of the grooves 31. As described with reference to FIG. 6(b), the pressing lid 32 has such a structure as to be able to adjust pressing force by the springs 33 and can apply the optimal tension to the conductive wires 1 such that the conductive wires 1 are not loosened when being wound on the dedicated reel 10.

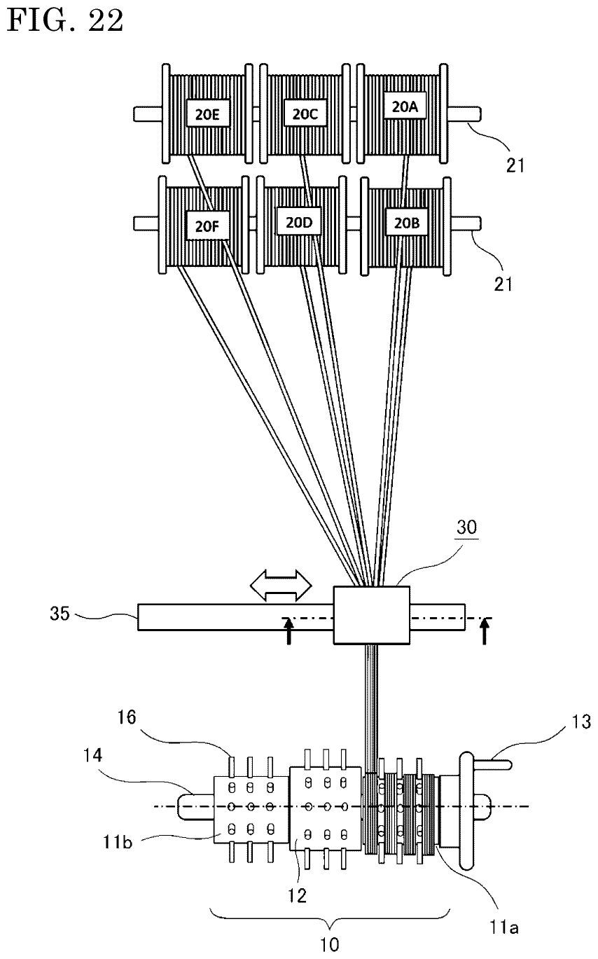

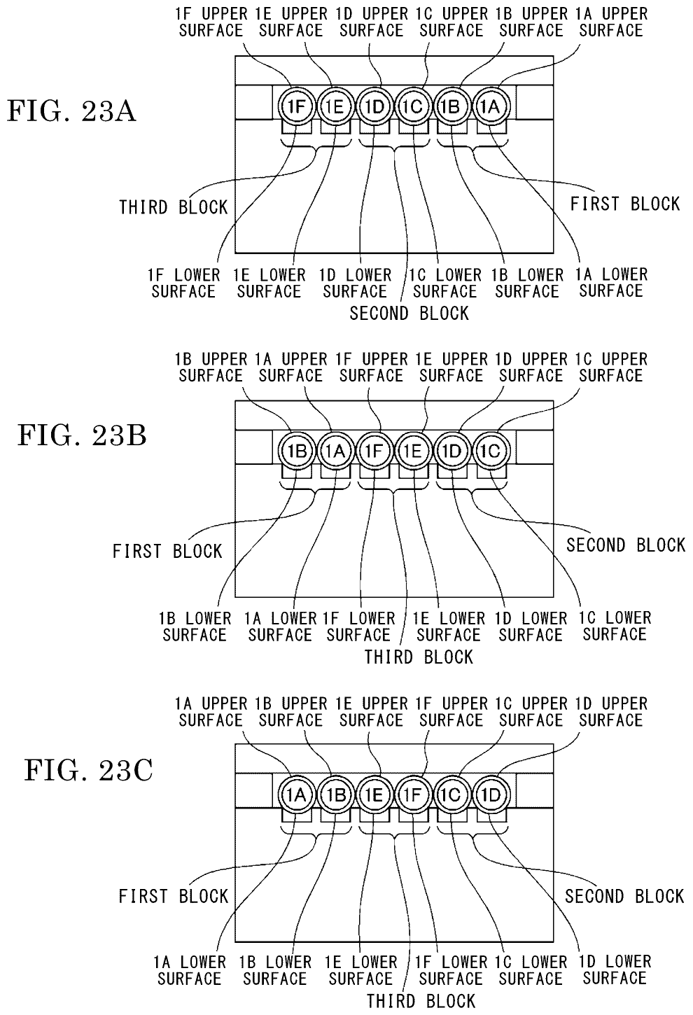

(4) When the winding on the reel 11a for a small coil the specified number of times is finished as in FIG. 22, the conductive wires are interchanged in terms of the arrangement order thereof. Specifically, in a case where the number of continuous coils for the same phase is defined as N and the number of the conductive wires is defined as X, the conductive wires are grouped into unit blocks each composed of X/N conductive wires, and the unit blocks are mutually interchanged. That is, in a case where there are three continuous coils for the same phase (the number of coils=3) and the number of the conductive wires is six (X=6), 6/3=2 is satisfied, i.e., the conductive wires are grouped into blocks each composed of two conductive wires, and the blocks are mutually interchanged. FIGS. 23(a) to 23(c) show arrangement orders of the conductive wires before and after the interchanging. FIG. 23(a) shows a state before the interchanging, and FIG. 23(b) and FIG. 23(c) show states after the interchanging. At the time of the interchanging, as shown in FIG. 23(c), the conductive wires in each of the blocks are desirably mutually interchanged, but, as in FIG. 23 (b), the conductive wires in the blocks do not have to be mutually interchanged.

Also, the conductive wires A to F are interchanged without being twisted, and thus the upper surface and the lower surface of each of the conductive wires are not reversed between before and after the interchanging. That is, a state is obtained where, in a cross section of a jumper wire portion, wires are interchanged in terms of an arrangement order in one direction of the wires and are not interchanged in terms of an arrangement order in another direction orthogonal to the one direction.

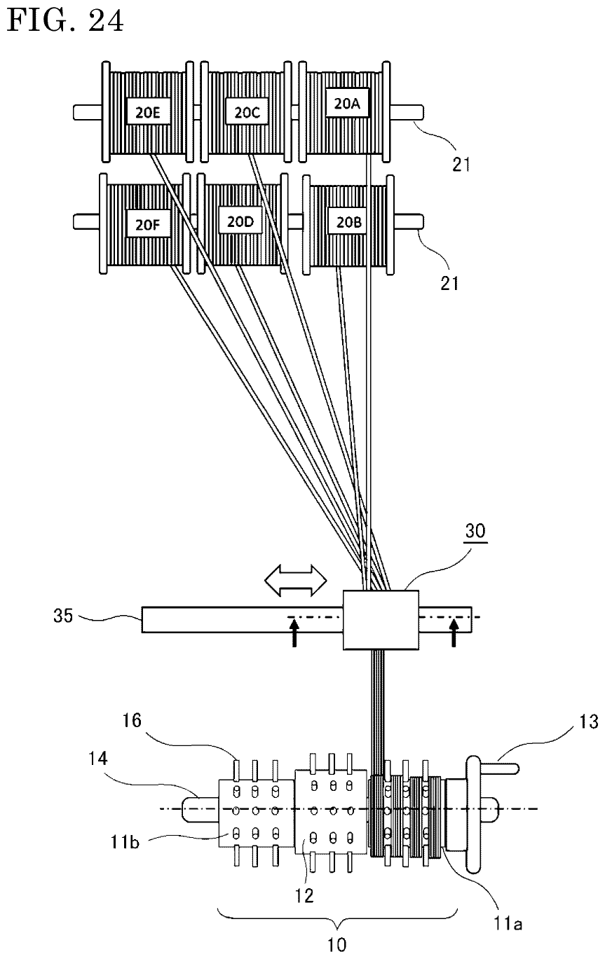

In a case where the value of X/N is not an integer, adjustment is performed as much as possible such that the number of times of interchanging becomes the same among the conductive wires. Specifically, in a case where the number of the continuous coils is 3 and the number of the conductive wires is 5, 5/3=1.67 is satisfied, and in this case, the first block may be composed of one conductive wire, the second block may be composed of two conductive wires, and the third block may be composed of two conductive wires, for example. A state after the conductive wires are interchanged is shown in FIG. 24. The conductive wires 1 have been interchanged in terms of the arrangement thereof before a second coil is obtained through winding on the reel 12 for a large coil. Subsequently, the conductive wires 1 are moved to the position for performing winding on the reel 12 for a large coil, and are wound in the same manner as that described above without cutting the conductive wires A to F. That is, a structure is obtained in which, across the jumper wire between the small coil 6a as the first coil and the large coil 7 as the second coil, the wires are interchanged in terms of the arrangement order in the one direction and are not interchanged in terms of the arrangement order in the other direction orthogonal to the one direction. The distortion remover 30 includes the movement means 35 and allows winding while being slid in the direction of the rotation shaft 14 so as not to bend the conductive wires A to F, with the angle of each of the conductive wires A to F relative to the dedicated reel 10 being constantly kept as a right angle. The subsequent step of obtaining a large coil through winding is the same as that in embodiment 1, but, since the conductive wires have been interchanged in terms of the arrangement order thereof, a coil composed of the rearranged conductive wires is formed.

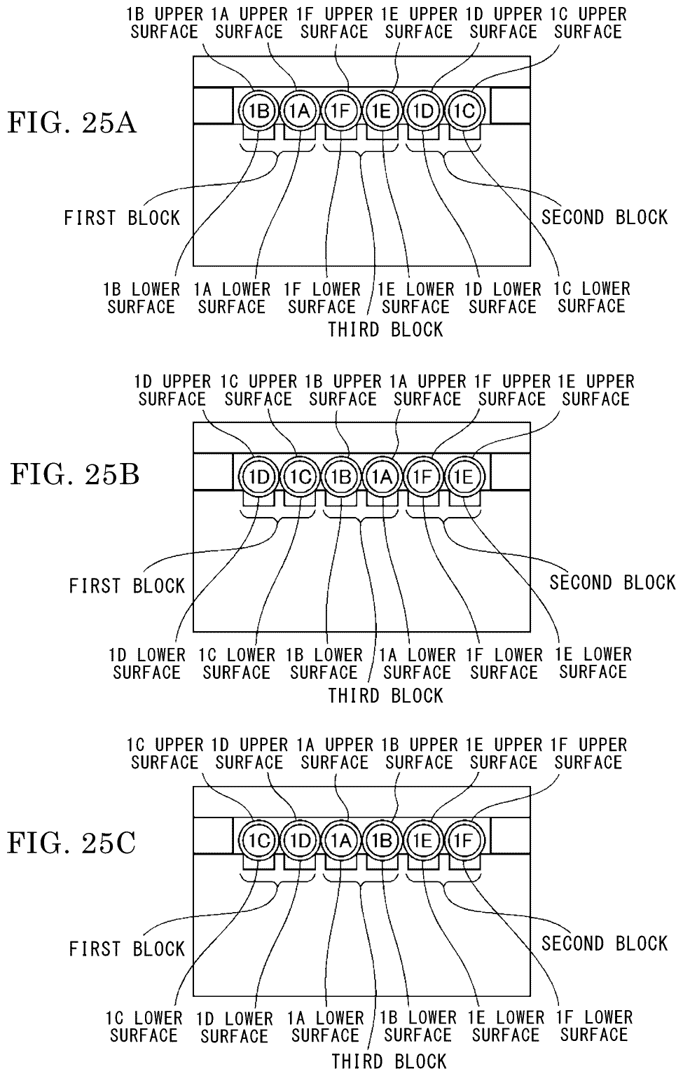

Next, after the large coil is obtained through winding on the reel 12 for a large coil, the unit blocks into which the conductive wires A to F have been grouped are mutually interchanged in the same manner as that described above. FIGS. 25(a) to 25(c) show states before and after the interchanging. As shown in FIG. 25(b), the conductive wires in the blocks do not have to be mutually interchanged. Alternatively, as shown in FIG. 25(c), the conductive wires in each of the blocks may be mutually interchanged. After the conductive wires A to F are interchanged, the conductive wires 1 are moved to the position for performing winding on the reel 11b for a small coil as a third reel, and are wound without cutting the conductive wires A to F. That is, a structure is obtained in which, across the jumper wire between the large coil 7 as the second coil and the small coil 6b as the third coil, the wires are interchanged in terms of the arrangement order in the one direction and are not interchanged in terms of the arrangement order in the other direction orthogonal to the one direction. Thereafter, the small coil 6b as the third coil is obtained through winding. In the same manner as in the case of the large coil, the conductive wires A to F have been interchanged in terms of the arrangement order thereof, and thus a coil composed of the rearranged conductive wires is formed.

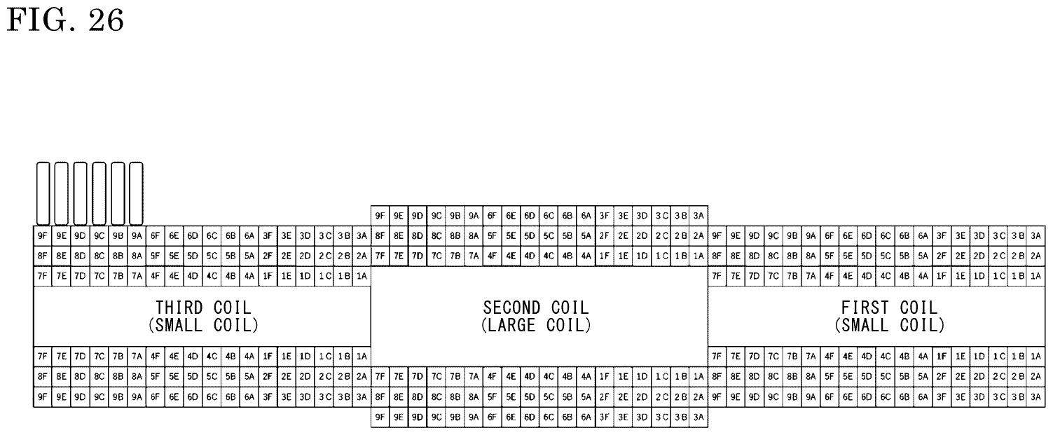

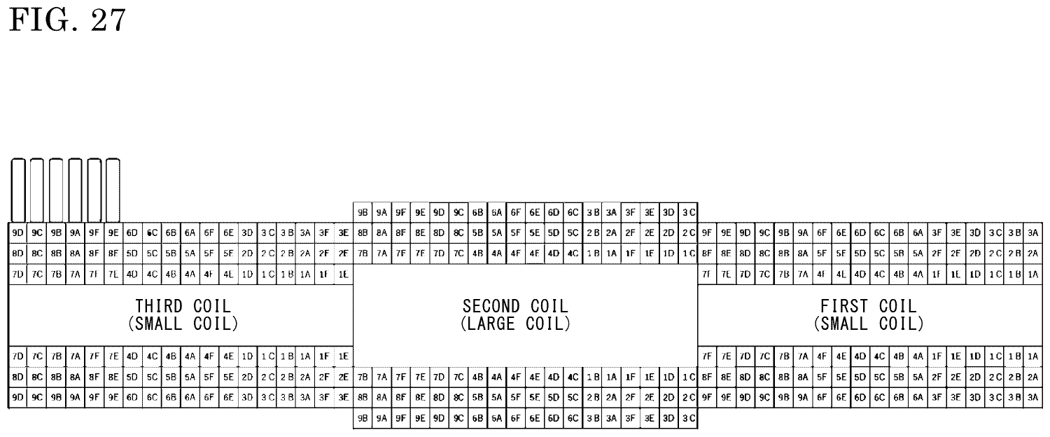

FIG. 26 shows an arrangement order of the three-continuous coil obtained through the winding as in embodiment 1, and FIG. 27 shows an arrangement order of the three-continuous coil obtained through the winding as in embodiment 2. In FIG. 26 and FIG. 27, 1A to 1F indicate the respective conductive wires, from the wire material drums 20A to 20F, which have been wound at the first turn, and 2A to 2F indicate the respective conductive wires, from the wire material drums 20A to 20F, which have been wound at the second turn. The same applies to the other reference characters.

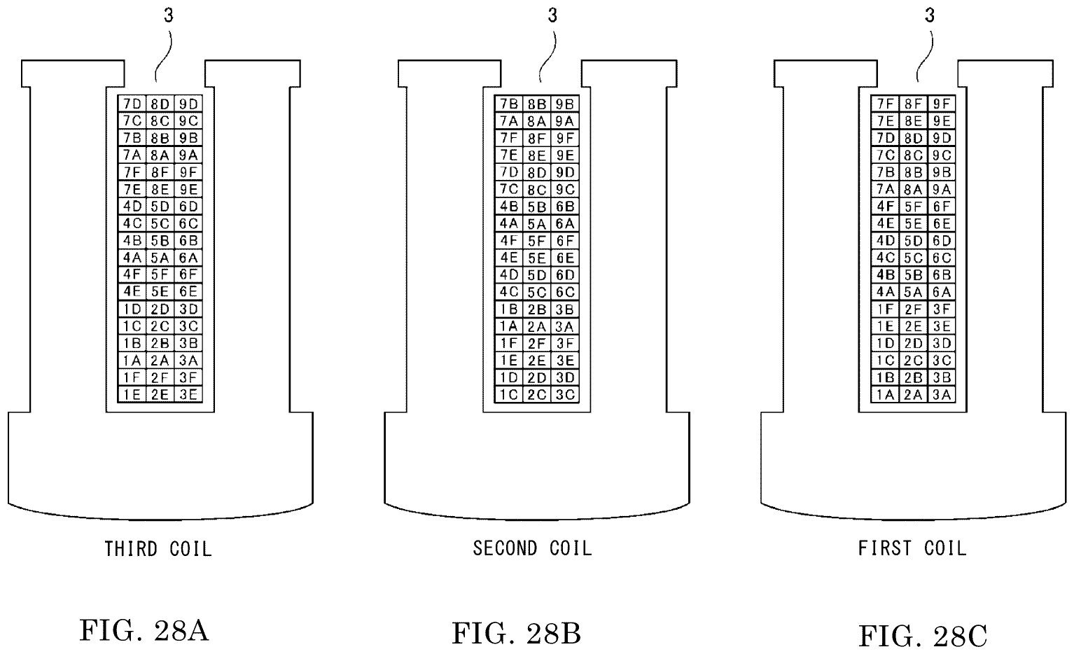

In FIG. 26, the order of winding for each of the first coil (the coil obtained through winding on the reel 11a for a small coil), the second coil (the coil obtained through winding on the reel 12 for a large coil), and the third coil (the coil obtained through winding on the reel 11b for a small coil) is A, B, C, D, E, and F from the right side on the drawing sheet with this order of winding being repeated. Meanwhile, in FIG. 27 regarding embodiment 2, the order of winding for the first coil is A, B, C, D, E, and F with this order of winding being repeated, the order of winding for the second coil is C, D, E, F, A, and B with this order of winding being repeated, and the order of winding for the third coil is E, F, A, B, C, and D with this order of winding being repeated. Consequently, as shown in FIGS. 28(a), 28(b), and 28(c), the order of the conductive wires inserted into a corresponding core slot 3 can be set to differ among the coils. In embodiment 1, the arrangement orders of the conductive wires, in core slots 3, forming the respective coils are, for all the core slots 3, the same as the arrangement order of the conductive wires in FIG. 28 (a). Although FIG. 26, FIG. 27, and FIGS. 28(a) to 28(c) show the conductive wires on the assumption that the conductive wires are rectangular wires each having a rectangular cross-sectional shape for simplifying the description, the conductive wires may be round wires. Also, although the coils are shown as if the conductive wires are wound in an arrayed manner even after the coils are inserted into the core slots 3, disarraying of the conductive wires after the insertion does not pose any problem.

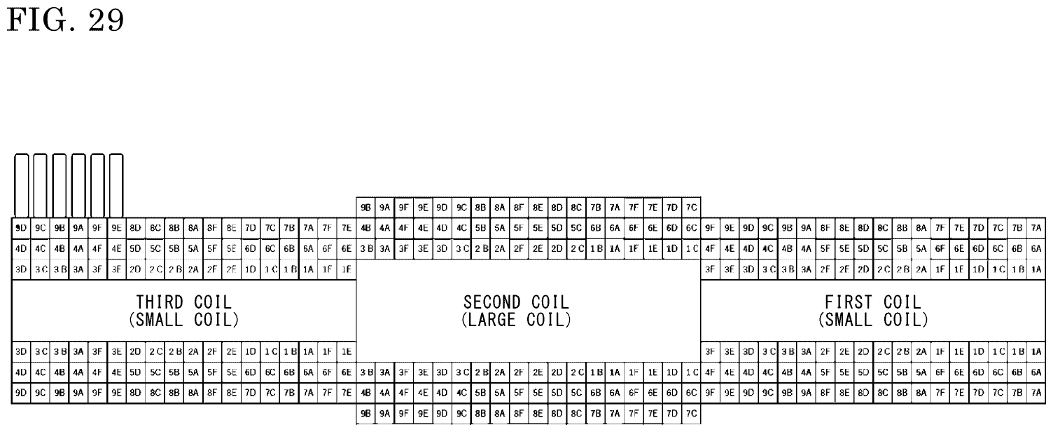

Regarding the winding orders of the respective coils, a process that includes performing winding a plurality of times without changing the position of the distortion remover 30, then shifting the position of the distortion remover 30, and performing winding the plurality of times again is performed a plurality of times as shown in FIG. 26. Alternatively, the position of the distortion remover 30 may be changed every time of winding. For example, as shown in FIG. 29, each of the coils obtained through the winding on the corresponding reel has a cross section in which: the conductive wires are disposed from the side closer to the reel; and the subsequently-wound conductive wires are disposed on the side farther from the reel.

Also, the winding direction may be, as necessary, set to differ among the coils.

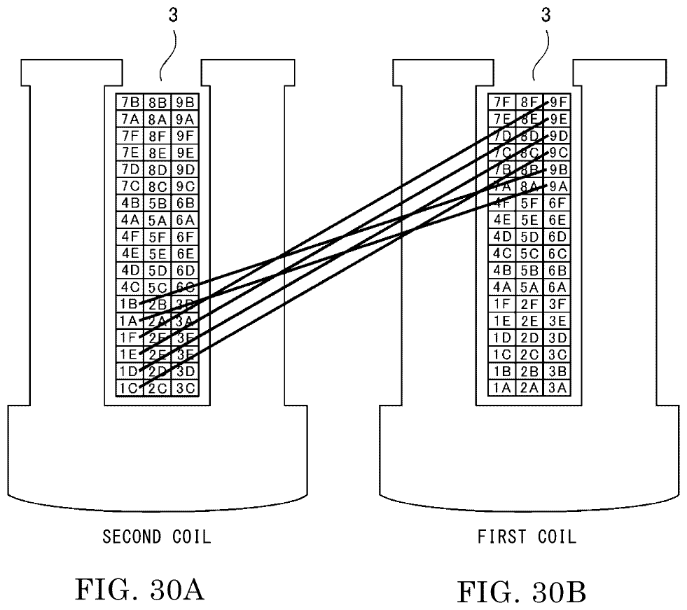

A structure regarding the jumper wire portion will be described in detail with reference to FIGS. 30(a) and 30(b). FIGS. 30(a) and 30(b) are schematic diagrams showing jumper wires extended on and between the first coil shown in FIG. 28 (c) and the second coil shown in FIG. 28 (b). The conductive wires are, after the small coil as the first coil is obtained through winding, interchanged in terms of the arrangement order thereof as shown in FIG. 23(b), and then the large coil as the second coil is obtained through winding. Thus, in this structure, the conductive wires are interchanged across the jumper wire portion. In addition, since the conductive wires are wound after being interchanged as shown in FIG. 23(b), the jumper wire portion is in a state where, between the coils, X/N conductive wires are interchanged in terms of the arrangement order in the one direction and are not interchanged in terms of the arrangement order in the other direction orthogonal to the one direction.

Next, advantageous effects in embodiment 2 will be described. Employment of the method according to embodiment 2 leads to the following advantageous effects. That is, in a case where the number of the continuous coils for the same phase is defined as N and the number of the conductive wires is defined as X, shifts by X/N conductive wires occur between the coils, whereby variation among the lengths of the respective conductive wires can be decreased. Consequently, the positions of the respective conductive wires in the core slots 3 are evenly interchanged between the coils, whereby variation among distributions in magnetic saturation with respect to the respective conductive wires at the time of driving the motor is decreased. Thus, variation among the inductances of the respective conductive wires can be decreased. Therefore, circulation current that is generated between the conductive wires can be decreased, and the efficiency of the motor can be increased.

### Embodiment 3

Hereinafter, a method for manufacturing a stator coil and a structure of a stator according to embodiment 3 will be described focusing on differences from the method and the structure according to embodiment 1. In embodiment 2, the positions of the conductive wires are interchanged between the coils, whereby the variation among the lengths of the respective conductive wires and the variation among the distributions in magnetic saturation with respect to the respective conductive wires at the time of driving the motor are decreased. Consequently, the variation among the inductances is decreased, whereby circulation current is decreased. However, in embodiment 2, the operation of interchanging the conductive wires between the coils has to be performed, whereby there is a concern that the number of steps is slightly increased. Embodiment 3 eliminates this concern in the following manner. That is, when a plurality of coils for the same phase are inserted into corresponding core slots 3, the direction of inserting at least one coil among the coils is inverted by 180 degrees, i.e., the corresponding jumper wire is inverted, and the arrangement order of the conductive wires at the time of insertion into the core slots 3 is inverted. Thus, the variation among the distributions in magnetic saturation with respect to the respective conductive wires is decreased. Consequently, with a smaller number of steps than that in embodiment 2, the variation among the distributions in magnetic saturation can be decreased, and the variation among the inductances of the respective conductive wires can be decreased. Furthermore, circulation current at the time of driving the motor can be decreased.

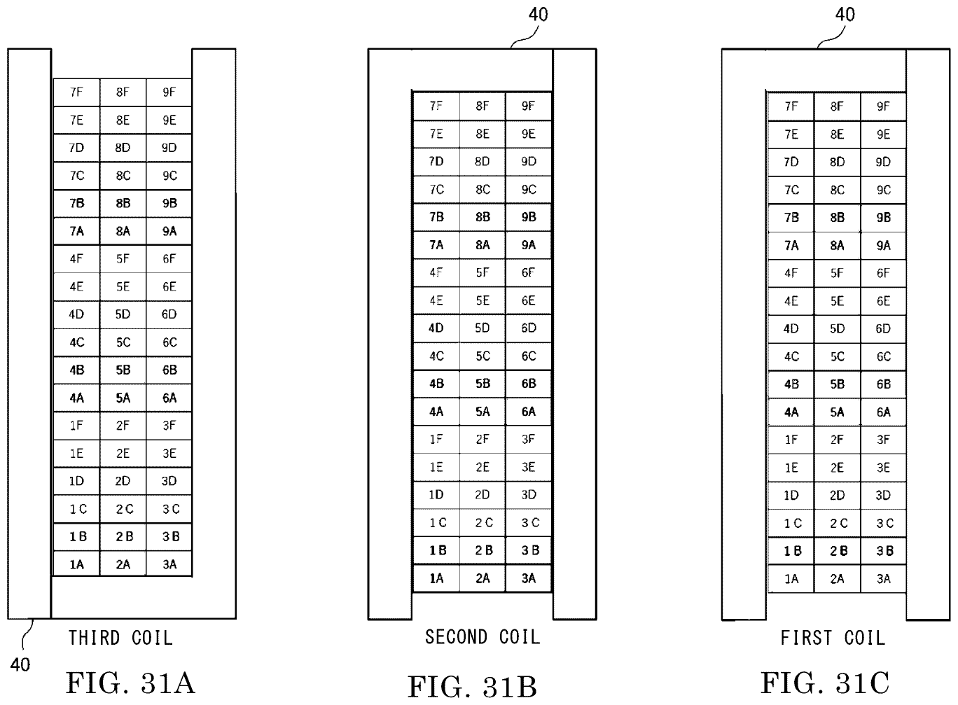

The manufacturing method and the structure will be specifically described focusing on differences from the manufacturing method and the structure according to embodiment 1. A “winding step” in embodiment 3 is the same as that in embodiment 1. A “grip-switching step” in embodiment 3 is such that, to at least one of the coils composing the three-continuous coil, a corresponding coil chuck 40 is attached in an opposite direction. Specifically, embodiment 1 is such that each coil chuck 40 is attached from the upper side toward the lower side on the drawing sheet of FIG. 10(a), whereas, as shown in FIG. 31(a), to at least one coil, a corresponding coil chuck 40 is attached from the lower side toward the upper side on the drawing sheet. It is noted that FIGS. 31(a) to 31(c) show cross sections taken in the same direction as the direction in FIG. 10(b) and show only coil chuck portions on half side for convenience. In FIGS. 31(a) to 31(c), only attaching to the small coil 6b as the third coil is performed in the opposite direction.

In embodiment 3, a “rotation step” is added to the steps in embodiment 1. Specifically, the coil chuck 40 attached to the coil in the opposite direction in the “grip-switching step” is rotated, i.e., inverted, by 180° around a longitudinal direction of the stator core 2 in which the coil is to be inserted into the corresponding core slot 3. Consequently, the coil insertion directions of all the coil chucks 40 can be set to be the same in the “insertion step”. However, since the coil chuck 40 and the coil are inverted at this time, the corresponding jumper wire portion is also inverted. A structure of the inverted jumper wires will be described later.

The “insertion step” in embodiment 3 is the same as that in embodiment 1. However, since the manner of gripping has been changed in the “grip-switching step”, the conductive wires are arranged in a different manner in the core slots 3 after the coils are inserted. This feature will be described in detail.

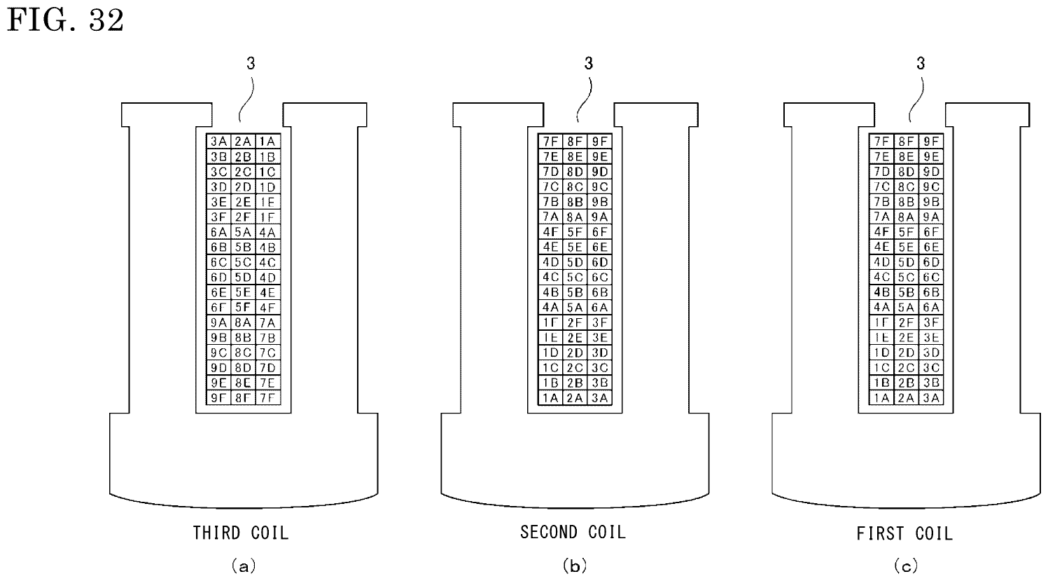

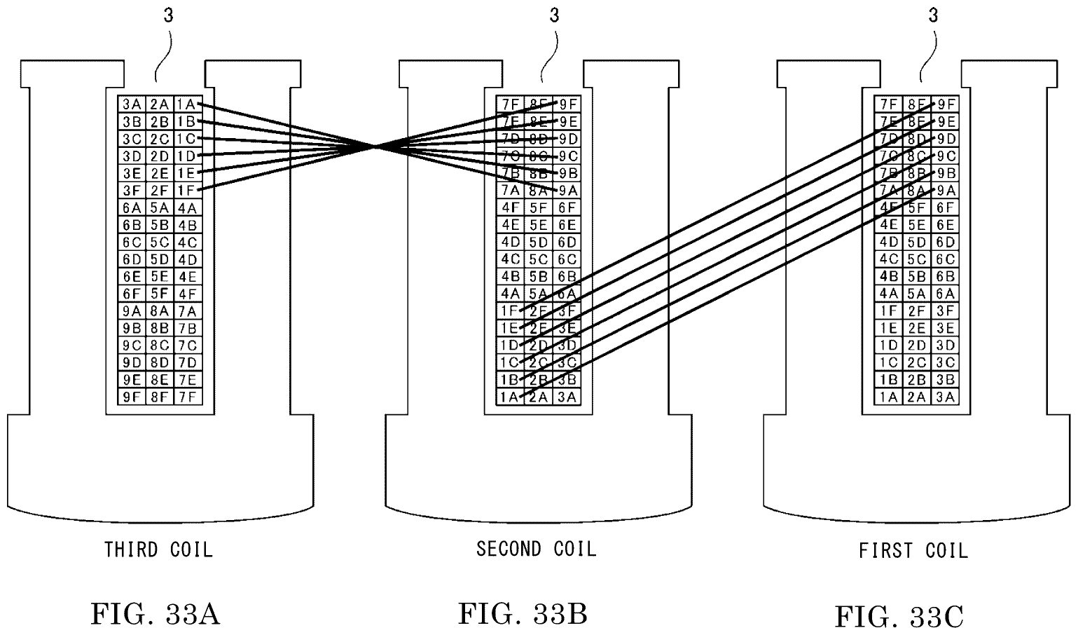

FIGS. 32(a) to 32(c) show the arrangement of the conductive wires after the coils are inserted into the corresponding core slots 3 in a case where only the coil chuck 40 for the third coil has been attached in the opposite direction. The conductive wires forming the first coil and the second coil are arranged in the order of A, B, C, D, E, and F from the lower side toward the upper side on the drawing sheet of each of FIGS. 32(a) to 32(c). Meanwhile, the conductive wires forming the inverted third coil are arranged in the order of F, E, D, C, B, and A from the lower side on the drawing sheet toward the upper side on the drawing sheet. As shown in FIGS. 33(a) to 33(c), the following structure is obtained. That is, jumper wires are not inverted in a case where neither of the attaching directions of the corresponding coil chucks 40 has been inverted, as in the case of the jumper wires between the first coil and the second coil, whereas jumper wires are inverted in a case where either of the attaching directions of the corresponding coil chucks 40 has been inverted, as in the case of the jumper wires between the second coil and the third coil. A winding end of the second coil and a winding start of the third coil in the corresponding jumper wire portion are each present on the core slot opening width 44 side inside the corresponding core slot 3.

Although a case where the number of the continuous coils for the same phase is three has been described in embodiment 3, the number of the continuous coils is not limited thereto and only has to be two or more. The positions of the conductive wire after inserting the coil into the core slot 3 with the coil chuck 40 having been attached in the opposite direction only have to be interchanged at least one time. In a case where the number of the continuous coils is an even number, it is effective to perform inversion one time, exactly at the position between the center coils (for example, in a case where the number of the continuous coils for the same phase is four, the position between the second coil and the third coil). As a matter of course, the directions of the coil chucks 40 may be changed coil by coil so that the positions of the conductive wires in the core slots 3 are inverted between the coils.

Next, advantageous effects in embodiment 3 will be described. By employing embodiment 3, the positions of the conductive wires in the core slots 3 are inverted between the coils, and thus the variation among the distributions in magnetic saturation with respect to the respective conductive wires at the time of driving the motor is decreased, and the variation among the inductances of the respective conductive wires can be decreased. Therefore, circulation current that is generated between the conductive wires can be decreased, and the efficiency of the motor can be increased.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the specification of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 conductive wire
2 stator core
3 core slot
4 rotor
5 coil
6a, 6b small coil
7 large coil
10 dedicated reel
11a, 11b, 12 reel
13 rotation handle
14 rotation shaft
15 conductive wire winding portion
16 restricting pin
17 slide mechanism
18 locking mechanism
20 wire material drum
21 shaft
30 distortion remover
31 groove
32 pressing lid
33 spring
35 movement means
40 coil chuck
40a shutter insertion groove
41 shutter
42a, 42b fixation jig
42c positioning protrusion
43 jig fixation spacer
44 core slot opening width
45 coil chuck width
46 slot inlet boundary
50 coil pusher

1. A method for manufacturing a stator coil, in which a plurality of conductive wires are wound on reels so as to form coils and the formed coils are inserted into core slots of a stator core, the method comprising:
a winding step of arraying the plurality of conductive wires in one row and winding, while maintaining an arrayed state, each of the conductive wires a predetermined number of times on each of a plurality of the reels having different diameters, to form a plurality of coils connected to each other by a jumper wire;
a gripping step of detaching each of the plurality of coils from the corresponding reel while maintaining the arrayed state of the plurality of conductive wires; and
an insertion step of disposing, in the stator core, the plurality of gripped coils so as to stack the coils in an order of insertion into the core slots, and then inserting the coils into the core slots.

2. The method for manufacturing a stator coil, according to claim 1, wherein the insertion step includes disposing, in the stator core, the plurality of gripped coils so as to stack the coils in a radial direction in the order of insertion into the core slots, and then inserting the coils into the core slots.

3. The method for manufacturing a stator coil, according to claim 1, wherein
the winding step includes forming the plurality of coils in which, in a case where the number of continuous coils for a same phase is defined as N and the number of the conductive wires is defined as X, units each composed of X/N conductive wires among the plurality of conductive wires are mutually interchanged in terms of an arrangement order in one direction and are not mutually interchanged in terms of an arrangement order in another direction orthogonal to the one direction.

4. The method for manufacturing a stator coil, according to claim 1, further comprising
a rotation step of, in order to invert a conductive wire disposition order of at least one coil among the plurality of coils and insert the at least one coil, rotating the at least one coil by 180° around a longitudinal direction of the stator core.

5. The method for manufacturing a stator coil, according to claim 1, wherein winding directions of at least two of the coils for a same phase are a same direction, the at least two coils being inserted into the corresponding core slots and being connected to each other by the corresponding jumper wire.

6. The method for manufacturing a stator coil, according to claim 1, wherein
the gripping step includes using a first jig for detaching each of the plurality of coils from the corresponding reel while maintaining the arrayed state of the plurality of conductive wires, and
the insertion step includes using a second jig for disposing a plurality of the first jigs having gripped the coils so as to stack the first jigs in a radial direction from a side closer to the core slots in the stator core, the second jig being for holding, without hindering insertion of one of the coils into the corresponding core slots, a first jig that has gripped another one of the coils among the first jigs.

7. The method for manufacturing a stator coil, according to claim 6, wherein gaps, of the first jigs, within which the coils are gripped each have a width smaller than an opening width of each of the core slots.

8. A method for manufacturing a rotating electrical machine, the method comprising
mounting a rotor to a stator manufactured according to the method for manufacturing a stator coil, according to claim 1.

9. A stator comprising:
N continuous coils for a same phase, the N continuous coils having X conductive wires and being connected to each other by a jumper wire, the N continuous coils being arrayed; and
a stator core having core slots into which the N continuous coils are inserted, wherein
between the N coils, units each composed of X/N conductive wires are mutually interchanged in terms of an arrangement order in one direction of the conductive wires and are not mutually interchanged in terms of an arrangement order in another direction orthogonal to the one direction.

10. A stator comprising:
a plurality of continuous coils for a same phase, the plurality of continuous coils being connected to each other by a jumper wire, the plurality of continuous coils being arrayed; and
a stator core having core slots into which the plurality of continuous coils are inserted, wherein
insertion into the core slots is performed with the jumper wire being inverted between the plurality of continuous coils for the same phase, and
two of the coils that are connected to each other by the corresponding jumper wire have a same winding direction.

11. (canceled)

12. The stator according to claim 10, wherein
the continuous coils for the same phase include a coil on one side of the jumper wire inverted between the continuous coils and a coil on another side of said jumper wire, and
a winding end of the coil on the one side and a winding start of the coil on the other side are present on a same side in a radial direction inside the corresponding core slots.

13. A rotating electrical machine comprising:
the stator according to claim 9; and
a rotor mounted to the stator.

14. A rotating electrical machine comprising:
the stator according to claim 10; and
a rotor mounted to the stator.

15. A rotating electrical machine comprising:
the stator according to claim 12; and
a rotor mounted to the stator.
